(19) United States
(12) Patent Application Publication
(10) Pub. No.: US 2023/0102162 A1
(43) Pub. Date: Mar. 30, 2023

(54) ACCELERATED FACT CHECKING WITH DISTRIBUTED LEDGERS

(71) Applicant: SAP SE, Walldorf (DE)

(72) Inventors: Anderson Santana De Oliveira, Antibes (FR); Cedric Hebert, Mouans Sartoux (FR)

(73) Assignee: SAP SE, Walldorf (DE)

(21) Appl. No.: 17/486,403

(22) Filed: Sep. 27, 2021

(51) Int. Cl. G06F 16/23; G06F 16/215

(52) U.S. Cl. CPC G06F 16/2365; G06F 16/215

(57) ABSTRACT

Systems, methods, and computer media are described for accelerated fact checking using distributed storage platforms (e.g., a blockchain or other distributed ledger) and trusted software providers. A claim for fact checking is received from a user (e.g., organization) of a software application managed by the trusted software provider. User-specific data associated with both the user and the application that is related to the claim can then be accessed (e.g., retrieved from a data store through queries). It can then be determined whether the claim is supported based on the user's own data. If the claim is supported, verification data for the claim can be generated and stored in a distributed storage platform (e.g., blockchain), where the verification data is available for others to use in fact checking.

### BACKGROUND

Dangerous content proliferates on the internet. False claims (a.k.a. “fake news”) have become a major instrument of mass manipulation and destabilization across the world. People in all societies are overloaded with information from traditional and social media. The technical environment provided by the internet, applications, and computing devices results in people having a very short time to assess the content they are exposed to before sharing with their own network of contacts and potentially continuing the cycle of disinformation.

### BRIEF DESCRIPTION OF THE DRAWINGS

FIG. 1 illustrates an example method of accelerated fact checking.

FIG. 2 illustrates an example system configured to perform accelerated fact checking using a distributed storage platform.

FIG. 3 illustrates an example accelerated fact checking method in which verification data is generated upon determining that a software application configuration complies with trust criteria.

FIG. 4 illustrates an example accelerated fact checking method for a natural language claim.

FIG. 5 is a diagram illustrating a generalized implementation environment in which some described examples can be implemented.

### DETAILED DESCRIPTION

The internet is rife with false claims. Platforms (e.g., social media platforms and websites) frequently take minimal measures to eliminate false information. Often, the goal of such platforms (and the algorithms that guide operation of the platforms) is to maximize traffic, therefore implicitly leveraging people's attraction to alarmist content. Social platforms typically delegate to users, governments, and non-governmental organizations the responsibility to raise flags about the dissemination of disinformation. Fighting fake news is one of today's major challenges because of the speed with which content can be produced and shared in the connected world.

The described examples address such disinformation by providing accelerated fact checking through use of distributed storage platforms (e.g., a blockchain or other distributed ledger) and trusted software providers. In enterprise software scenarios, a variety of users (e.g., organizations, companies, governments, or other entities) use or run a software application or suite of applications supplied by a software provider. In a web application scenario, for example, the software provider securely stores data, settings, etc., for each user. When a user of the software application makes a claim regarding something that is verifiable through the user's own data (e.g., sales are up 50% over the previous year, energy use is down 20%, gender pay gap has been reduced below 5%, etc.), the software provider can access the user's data to verify the claim.

The provider's verification indicating the claim is true can be stored in a distributed storage platform (e.g., blockchain), along with other information related to the claim, such as the type of data used for verification, a degree of confidence in the verification, and/or a claim identifier. The immutable nature of the blockchain and the trusted status of the software provider allow for rapid verification of claims that can be evaluated against a user's data. Third parties seeking verification that a claim is true can access verification information stored on the distributed storage platform by, for example, searching for the identifier of the claim.

A publication scoring system can be used to evaluate claims in content posted in a network (e.g., the internet). New publications (i.e., claims) can use previously published documents as references (i.e., sources) that have been themselves assessed with a veracity/trust score (that is the probability that the information is true, given the verifiable facts).

Auditable databases can serve as a basis for reliable information provenance. For instance, financial statements published by companies running Sarbanes-Oxley Act (SOX)-compliant software, such as SAP S4HANA, can be assigned a high trustworthiness score for the different attributes for each of its claims. This information can be directly added to a distributed ledger when the documents are published, making it simpler to verify facts referring to these financial statements. Confidential data is not disclosed, only veracity indicators (or other verification data) about a public statement are stored.

In another example scenario, consider a governmental health agency that publishes results about the COVID-19 pandemic. The agency could issue readily verifiable claims by using, for example, SAP software such as HANA and SAP Cloud Analytics, if the software is used in an auditable way, compliant with standards. This would make it harder to manipulate claims about infection rates, mortality, etc. related to the pandemic progression.

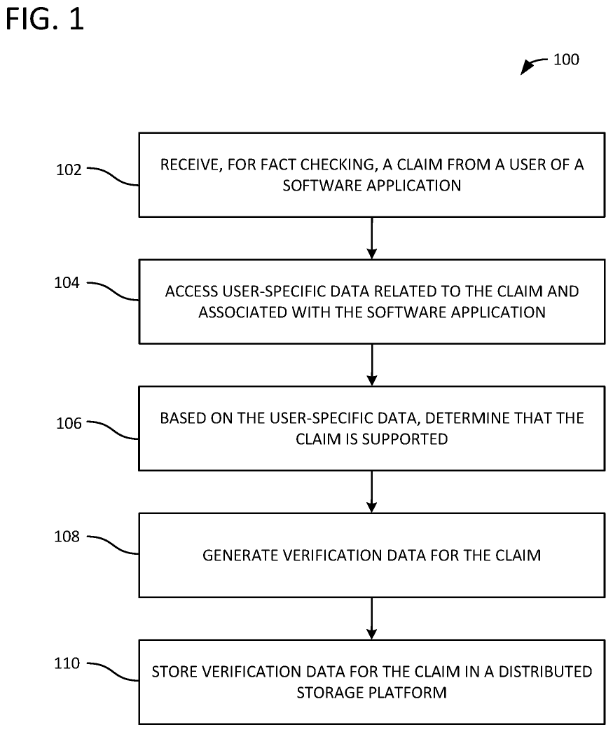

Examples are described below with reference to FIGS. 1-5.

Fact checking refers to verifying assertions made in a claim. Fact checking is difficult to perform autonomously and typically has some level of human involvement. The general verification of arbitrary claims requires deep understanding of the real world, local political and demographic context, and history. Fact checking can be thought of as including the following aspects: (1) extracting statements that are to be fact-checked; (2) constructing appropriate questions; (3) obtaining the pieces of evidence from relevant sources; and (4) reaching a verdict using that evidence.

FIG. 1 illustrates a method 100 of accelerated fact checking. In process block 102, a claim from a user of a software application is received for fact checking. “User” refers to individuals, organizations, companies, governments, or other entities. Example claims include “sales are up 50% over the previous year,” “energy use is down 20%,” “gender pay gap has been reduced below 5%,” “inventory has declined for 13 straight months,” etc.

In process block 104, user-specific data related to the claim and associated with the software application is accessed. Data used by, recorded in, or created through applications is typically stored in a database or other datastore and can be retrieved through queries (e.g., structured query language (SQL) queries). In cloud environments, a software provider can store data for multiple users in a single data store or in a distributed group of data stores.

In some examples, the claim is a natural language claim, and queries can be generated based on the natural language claim so that relevant data can be retrieved. For example, the SQL “SELECT” command, followed by data parameters such as field names and ranges, can be used to retrieve data. In the example of “the latest cost of treatment is X,” values for treatment costs can be retrieved using a SELECT command, ordered by date and limited to one result, to determine if the returned value is actually X. Various natural language processing and machine learning approaches can be used to generate queries based on natural language claims. For example, in research published by SAP (“Clause-Wise and Recursive Decoding for Complex and Cross-Domain Text-to-SQL Generation” by Dongjun Lee) automated machine translation was performed for a similar cost-of-treatment example—the results are shown below in Table 1. Queries can also be generated manually.

TABLE 1
Natural Language to SQL Conversion Example
NATURAL LANGUAGE SEQUENCE - How much does the most recent treatment cost?

| | |
|---|---|
| Ground Truth SQL code | SELECT cost_of_treatment FROM Treatments ORDER BY date_of_tr |
| | eatment DESC LIMIT 1 |
| Predicted code | SELECT cost_of_treatment FROM Treatments ORDER BY cost_of_tr |
| | eatment DESC LIMIT 1 |

In process block 106, it is determined, based on the user-specific data, that the claim is supported. Continuing the cost-of-treatment example, if the latest cost of treatment is in fact X, the claim is supported. Whether a claim is supported can be a yes/no decision or can be assessed on a scale, whether numeric or otherwise (e.g., “more likely than not,” “70% confidence,” “⅗,” etc.)

In process block 108, verification data is generated for the claim. Verification data can include a variety of information, including an identifier for the claim and one or more credibility attributes providing information regarding the assessment of whether the claim is supported. Example credibility attributes can include an inference indicator representing a level of correlation between the user-specific data and the claim, a citation indicator representing the citation of third-party information in the claim, a data relevance indicator representing an amount and relevance of the user-specific data to the claim, or an external validation indicator representing an external audit of the user and/or user's data used to support the claim.

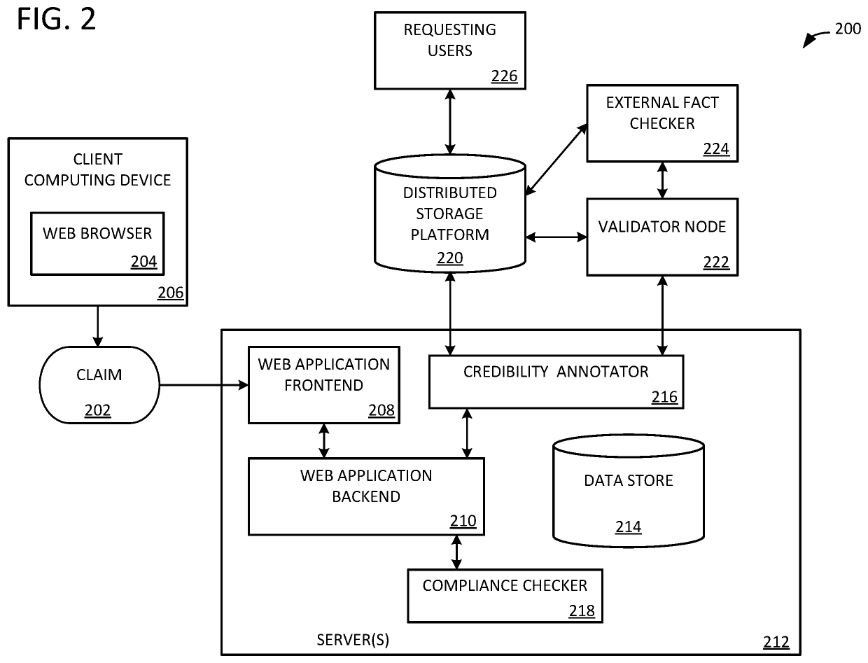

Credibility attributes provide supporting evidence to an assessment that a claim is supported without revealing (potentially confidential) details about the data used to verify the claim. Credibility attributes can be automatically generated by, for example, a “credibility annotator” as shown in FIG. 2. Other credibility attributes include a version of the user's system or software, a date and/or time data was retrieved or attributes were generated, the state of the user's software application compliance, etc.

In process block 110, the verification data for the claim is stored in a distributed storage platform. A distributed storage platform uses distributed devices and storage locations to replicate and synchronize data and establish a consensus between nodes. This arrangement provides security via consensus and eliminates the need for centralized management. Blockchain is an example of a distributed ledger and is one type of distributed storage platform technology. Various examples herein are discussed with respect to blockchain or distributed ledgers generally but can be implemented using other distributed storage platforms.

As used herein, “blockchain” refers to a distributed storage platform and network in which individual “blocks” are connected in a chain. Blocks are stored on nodes, which can be various distributed computing devices. Each block is linked to the previous block in the blockchain by, for example, including a hash of the previous block (referencing the previous block). Various hash functions, including functions in the Secure Hash Algorithm (SHA)-1 or -2 families, such as SHA-256, can be used to perform a one-way hash. Various “slow hashing” algorithms such as “bcrypt” can also be used. For a one-way hash, it is generally considered to be impossible or impractical to generate the input (the “message”) to the hash function based on the output (the “message digest” or “digest”) of the hash function.

A blockchain relies on security features and distributed consensus to achieve its implementation by a peer-to-peer network of nodes without any trust assumption among them. Blockchains essentially record in a ledger the transactions between two nodes of the network: such transactions are signed by at least one of the actors. Once signed, a transaction is transferred to the other nodes, called verifiers, that ensure its validity, and the transaction or transactions are added to a block (appended to the tail of the chain of existing blocks), becoming an official element of the blockchain.

Distributed consensus is achieved through the decision process of the verifiers, which can vary depending on the type of blockchain topology being used. There are essentially two types of blockchain: private or public (access). Private blockchains are normally defined as permissioned, in which blockchain services are regulated and nodes may use them only if authorized. Conversely, public blockchains are permissionless, and blockchain network services can be called freely by nodes. In permissionless blockchains, the choice of the consensus mechanism governs the transaction validation. Complex mechanisms can deter attacks like node identity spoofing or forging. In permissioned blockchains, consensus mechanisms can be much simpler and faster than such complex mechanisms given the assumption that nodes are identified and authorized centrally.

Blockchain technologies typically make extensive use of cryptography for their implementation, also including interactions with end-users. Independently from the type of ledger (permissionless or permissioned), end-users are associated with asymmetric keys (public and private keys) to operate on the blockchain; therefore, wallet software solutions (be them as-a-service or on end-user's local devices) can be used to simplify their management.

In the described examples, claims can have an identification number with which the ledger can be queried. Verification data, such as credibility attributes, metadata, etc, can be retrieved that were provided by the user's software application (e.g., a SAP HANA database, or an SAP S4HANA ERP system) or by an external fact checker.

In some examples, prior to storing the verification data for the claim, compliance of a configuration of the software application for the user with one or more trust criteria is verified. The trust criteria can include application settings, governance policies, etc. For example, verification data can only be stored in the distributed storage platform if various accounting and business standard practices are adhered to, which reduces or eliminates the chance that the user has modified their own data so that their claim will be verified even though the claim is not in fact true.

After verification data has been stored in the distributed storage platform, it is available for other users to access. In some examples, an index is generated that relates claim identifiers and distributed storage platform locations for claims for which verification data is stored in the distributed storage platform. The index can also include related key words.

FIG. 2 illustrates a system 200 configured for accelerated fact checking. A claim 202 is submitted by web browser 204 executing on client computing device 206. Web browser 204 and client computing device 206 are associated with an organization (e.g., a company) and provide access to a web application managed by a software provider. Claim 202 is submitted through web application frontend 208 to web application backend 210. Web application frontend 208 and backend 210 are implemented on one or more servers 212 (e.g., servers in a cloud computing environment) associated with the software provider.

Web application backend 210 communicates (e.g., through one or more APIs) with data store 214, credibility annotator 216 and compliance checker 218 to assess claim 202. Credibility annotator 216 queries data store 214 in an automated way to select evidence supporting claim 202. Credibility annotator 216 can be a machine learning model trained with proprietary data, associating natural language statements to database queries (e.g., in SQL or other relevant languages). Consider the following example claim: “our company has achieved zero gender pay gap in 2021.” Such a statement can be made public, but the specific salaries for all job profiles for men and women are likely not public and should remain confidential.

Credibility annotator 216 will then query data store 214 (e.g., a database associated with an SAP HR system) to verify salaries in 2021 and insert into the distributed storage platform 220 an annotation asserting that a query demonstrating this fact was performed with a true outcome. Access to credibility annotator 216 can be limited so that a human agent cannot add credibility attributes (sometimes also referred to as credibility indicators) manually or intercept communication from credibility annotator 216.

Some examples of credibility attributes that can be automatically generated by credibility annotator 216 include an inference indicator representing a level of correlation between the user-specific data and the claim, a citation indicator representing the citation of third-party information in the claim, a data relevance indicator representing an amount and relevance of the user-specific data to the claim, or an external validation indicator representing an external audit of the user. Credibility indicators are selected to not reveal confidential information.

Compliance checker 218 verifies that the software application configuration meets trust criteria. As an example, for companies publicly traded in the stock market, SOX compliance is mandatory. For a company running S4HANA, for example, compliance checker 218 goes through enabled Governance, Risk and Compliance controls, to check if appropriate authorizations are in place, segregation of duty, etc., to provide a score or scores for credibility attributes supporting claims related to financial statements.

Validator node 222 determines if verification data produced by credibility annotator 216 is proper (proper format, has proper public key, claim identifier, credibility attributes, etc.).

Human fact checkers can interact with external fact checker 224 to provide further verification of claims or verification of claims for which software application data cannot be used to verify the claim. External fact checker 224 queries distributed storage platform 220 for existing evidence supporting claims. Entries referring to the claims in question may contain verification data such as metadata linked to supporting evidence that would not need to be re-checked by the fact checker. If such evidence refers to data in auditable and compliant systems (verified as discussed with respect to method 100 of FIG. 1, for example), virtually no further effort is necessary to verify this claim. For instance, if a company issues a statement that the pay gender gap has decreased to zero, credibility annotator 216 will certify with data obtained from the compliant HR system (e.g., SAP SuccessFactors), stored in data store 214, generating verification data and metadata supporting that claim. This verification data is stored in distributed storage platform 220 and accessed by external fact checker 224.

Human fact checkers can also rank claims and/or users after verification (e.g., 10/10 for a claim validated based on application data), and external fact checker 224 can provide the ranking to distributed storage platform 220. Other request users 226 who access distributed storage platform 220 to verify the claim will find the both the verification data provided by credibility annotator 216 and the ranking provided through external fact checker 224. The human fact checkers themselves can also be ranked for trustworthiness and reliability. Thus, if stored in association with a claim identifier is a high ranking from a highly ranked human fact checker, a claim can also be considered to be true. Human fact checkers can be managed by a governance body and have their performance reviewed periodically.

Distributed storage platform 220 can be a distributed permissionless ledger. The ledger can contain, for example, a reference to a claim such as news, blog posts, financial statements, reports, or any kind of uniquely identifiable public information. The ledger can also contain metadata supporting the claims and references to or characterizations of data supporting the claim.

Distributed storage platform 220 can also store an identifier of a fact checker, the attributes supporting the assessment for the claim, and the corresponding credibility/trust scores the fact checker has assigned for a claim. An assessment about a previous fact checking, created by another fact checker, can also be stored in distributed storage platform 220. This kind of entry can affect the reputation of a fact checker. Fact checkers with bad reputation scores will likely have no influence over time. This can be achieved using some type of trust score calculation.

When organizations who are users of a software application start using the application, the organization is onboarded and assigned a secure public/private key pair that identifies them. The provider of the software application keeps a registry of public keys. Users can only sign distributed storage platform 220 with their own key.

As another example of the operation of systems such as system 200, a user creates a document containing claims. Claims have associated metadata. For instance, a cloud company states that cloud bookings are up 10%. The claims are supported by data from its data store that is associated with an enterprise software system. A credibility annotator has the relevant metadata mapping for the document. It then makes a request to the compliance checker.

The compliance checker verifies that all relevant controls are enabled—all technical measures that prevent the company from creating false cloud bookings in the software system. If this succeeds, evidence and their credibility indicators are generated by the credibility annotator for inclusion in the ledger. If compliance controls are not enabled, the credibility annotator will not include evidence supporting those claims for storage in the ledger. In some examples, claims are only verified for compliant systems.

The validator node will then allow the block to be written in the ledger by checking its conformity and by adding to it further indicators of credibility based of the trust score for that user.

When fact checkers select documents having claims for verification, they can use existing ledger elements to refute claims in new publications easily since they have indicators of veracity. Fact checkers can rely on the automatically generated indicators to support public sector claims in several areas, like climate change and health quickly because they will be able to trust the automatically generated metadata. The ledger will make the process transparent to all stakeholders.

Malicious fact checkers can issue credibility statements for claims asserting that fake news is true. These can be refuted by honest fact checkers, which can refute them using the ledger. The volume of fake news will be limited because the validator node can refuse documents with supporting claims that were demonstrated false immediately.

Conversely, malicious fact checkers won't be able to refute true claims verified by honest fact checkers as their trust score will not be able to find true supporting evidence to invalidate previously published reliable content in the ledger.

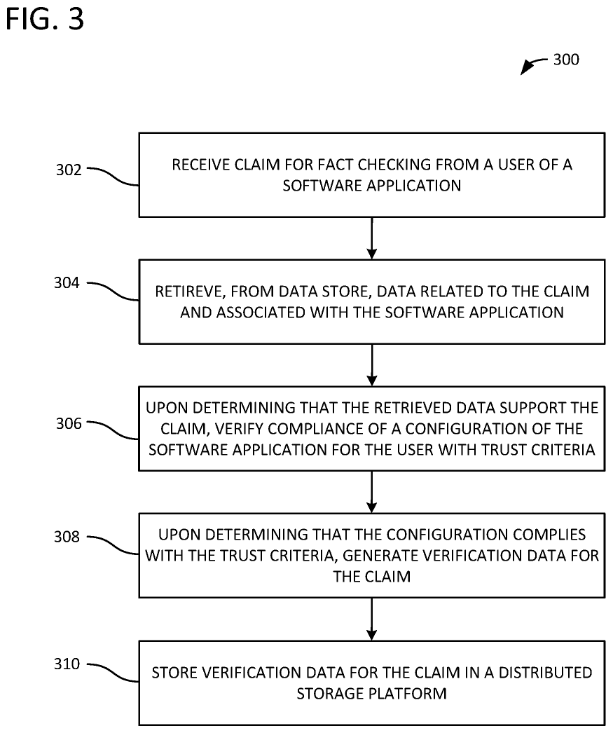

FIG. 3 illustrates a method 300 of accelerated fact checking. In process block 302, a claim for fact checking is received from a user of a software application. In process block 304, data related to the claim and associated with the software application is retrieved from one or more data stores. Upon determining that the retrieved data support the claim, compliance of a configuration of the software application for the user with one or more trust criteria is verified in process block 306. In process block 308, verification data for the claim is generated upon determining that the configuration complies with the one or more trust criteria. In process block 310, the verification data for the claim is stored in a distributed storage platform.

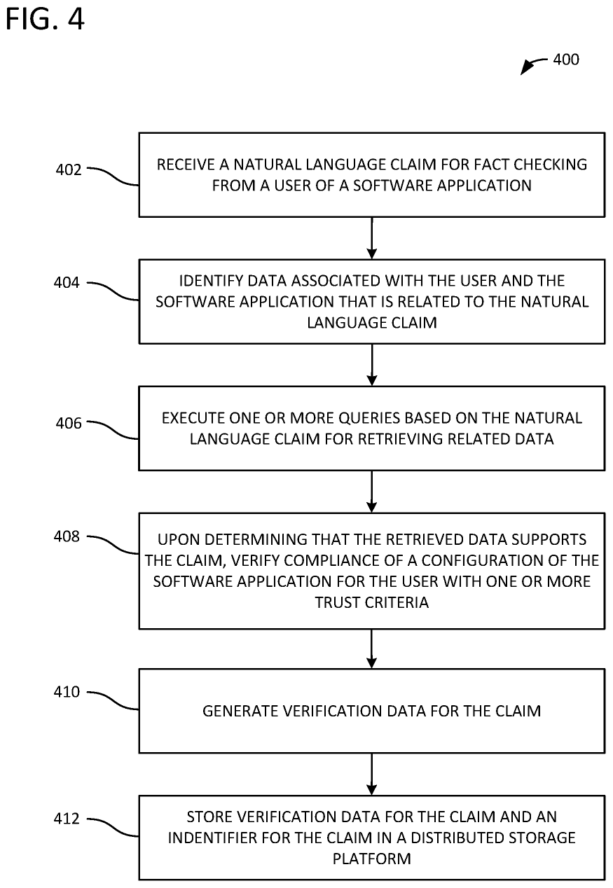

FIG. 4 illustrates a method 400 of accelerated fact checking. In process block 402, a natural language claim is received for fact checking from a user of a software application. In process block 404, data in one or more data stores is identified that is related to the natural language claim. The data is associated both with the user and the software application. In process block 406, one or more queries are executed, based on the natural language claim, for retrieving at least some of the related data. In process block 408, upon determining that data retrieved through the one or more queries supports the claim, compliance of a configuration of the software application for the user with one or more trust criteria is verified. The one or more trust criteria include an application setting or a governance policy. Upon determining that the configuration complies with the one or more trust criteria, verification data for the claim is generated in process block 410. The verification data for the claim and an identifier for the claim are stored in a distributed storage platform in process block 412. The verification data for the claim is accessible to other users of the distributed storage platform.

### Example Computing Systems

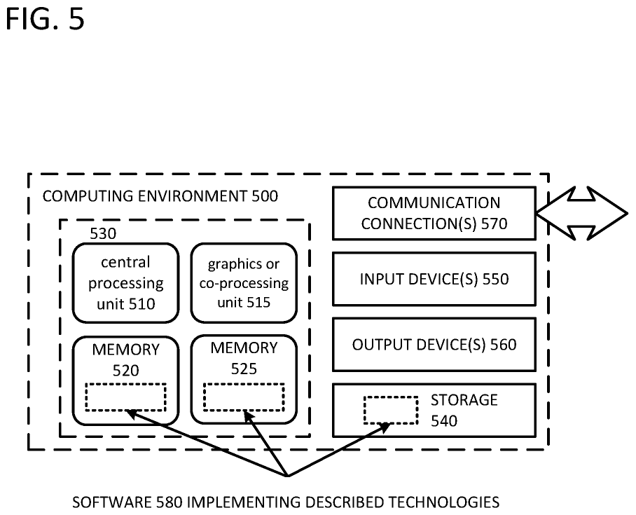

FIG. 5 depicts a generalized example of a suitable computing system 500 in which the described innovations may be implemented. The computing system 500 is not intended to suggest any limitation as to scope of use or functionality, as the innovations may be implemented in diverse general-purpose or special-purpose computing systems.

With reference to FIG. 5, the computing system 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more innovations described herein, in the form of computer-executable instructions suitable for execution by the processing unit(s). For example, memory 520 and 525 can store credibility annotator 216 and compliance checker 218 of FIG. 2.

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information and which can be accessed within the computing system 500. The storage 540 stores instructions for the software 580 implementing one or more innovations described herein. For example, storage 540 can store credibility annotator 216 and compliance checker 218 of FIG. 2.

The input device(s) 550 may be a touch input device such as a keyboard, mouse, pen, or trackball, a voice input device, a scanning device, or another device that provides input to the computing system 500. For video encoding, the input device(s) 550 may be a camera, video card, TV tuner card, or similar device that accepts video input in analog or digital form, or a CD-ROM or CD-RW that reads video samples into the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 5, computer-readable storage media include memory 520 and 525, and storage 540. The term computer-readable storage media does not include signals and carrier waves. In addition, the term computer-readable storage media does not include communication connections (e.g., 570).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

We claim:

1. An accelerated fact-checking method, comprising:
receiving, for fact checking, a claim from a user of a software application;
accessing user-specific data related to the claim and associated with the software application;
based on the user-specific data, determining that the claim is supported;
generating verification data for the claim; and
storing the verification data for the claim in a distributed storage platform.

2. The method of claim 1, further comprising, prior to storing the verification data for the claim, verifying compliance of a configuration of the software application for the user with one or more trust criteria.

3. The method of claim 2, wherein the one or more trust criteria comprises at least one of an application setting or a governance policy.

4. The method of claim 1, wherein the user is an organization, and wherein the user-specific data comprises records for the organization accessible through the software application.

5. The method of claim 1, wherein the verification data comprises a claim identifier.

6. The method of claim 5, further comprising:
receiving a verification query containing the claim identifier; and
accessing the distributed storage system and retrieving at least some of the stored verification data.

7. The method of claim 7, the method further comprising generating an index relating claim identifiers and distributed storage platform locations for a group of claims for which verification data is stored in the distributed storage platform.

8. The method of claim 1, wherein the verification data comprises one or more credibility attributes.

9. The method of claim 8, wherein the one or more credibility attributes comprise at least one of: an inference indicator representing a level of correlation between the user-specific data and the claim, a citation indicator representing the citation of third-party information in the claim, a data relevance indicator representing an amount and relevance of the user-specific data to the claim, or an external validation indicator representing an external audit of the user.

10. The method of claim 1, wherein the claim is a natural language claim and wherein accessing user-specific data comprises generating one or more data store queries based on the natural language claim.

11. The method of claim 1, further comprising recording, in the distributed storage platform, a trust score for the user based on a history of claims of the user.

12. The method of claim 1, further comprising recording, in the distributed storage platform, a trust score for the claim assigned by an external fact checker.

13. The method of claim 1, wherein a private key for the user is associated with the verification data stored in the distributed storage platform.

14. The method of claim 1, wherein the distributed storage platform is a blockchain.

15. A computing system configured to execute computer-readable instructions for performing accelerated fact checking operations, the operations comprising:
receiving a claim for fact checking from a user of a software application;
retrieving, from one or more data stores, data related to the claim and associated with the software application;
upon determining that the retrieved data support the claim, verifying compliance of a configuration of the software application for the user with one or more trust criteria;
upon determining that the configuration complies with the one or more trust criteria, generating verification data for the claim; and
storing the verification data for the claim in a distributed storage platform.

16. The computing system of claim 15, wherein the one or more trust criteria comprises at least one of an application setting or a governance policy.

17. The computing system of claim 15, wherein the verification data comprises an identifier for the claim and one or more credibility attributes, and wherein the operations further comprise generating a trust score for at least one of the claim or the respective credibility attributes.

18. The computing system of claim 17, wherein the operations further comprise:
receiving a verification query containing the claim identifier; and
accessing the distributed storage system and retrieving at least some of the stored verification data.

19. The computing system of claim 17, wherein the operations further comprise upon receiving an assessment of the claim by an external fact checker, modifying the trust score.

20. One or more computer storage devices storing computer-executable instructions for accelerated fact checking, the accelerated fact checking comprising:
receiving a natural language claim for fact checking from a user of a software application;
identifying data in one or more data stores, associated with both the user and the software application, that is related to the natural language claim;
executing one or more queries, based on the natural language claim, for retrieving at least some of the related data;
upon determining that data retrieved through the one or more queries supports the claim, verifying compliance of a configuration of the software application for the user with one or more trust criteria, the one or more trust criteria including an application setting or a governance policy;
upon determining that the configuration complies with the one or more trust criteria, generating verification data for the claim; and
storing the verification data for the claim and an identifier for the claim in a distributed storage platform, wherein the verification data for the claim is accessible to other users of the distributed storage platform.
